(19) United States
(12) Patent Application Publication
(10) Pub. No.: US 2026/0180080 A1
(43) Pub. Date: Jun. 25, 2026

(54) SECONDARY BATTERY POUCH FILM AND POUCH-TYPE SECONDARY BATTERY INCLUDING THE SAME

(71) Applicant: Youlchon Chemical Co., Ltd., Seoul (KR)

(72) Inventors: Nok Jung SONG, Seoul (KR); Chang Woo Lee, Ansan-si (KR); Hui Hun Kim, Ansan-si (KR); Jin Hee Yeon, Ansan-si (KR); Sung Chul Shin, Ansan-si (KR); Moon Kyu Song, Ansan-si (KR)

(73) Assignee: Youlchon Chemical Co., Ltd., Seoul (KR)

(21) Appl. No.: 19/365,420

(22) Filed: Oct. 22, 2025

(30) Foreign Application Priority Data
Dec. 19, 2024 (KR) 10-2024-0191163

(51) Int. Cl. H01M 50/105; H01M 50/119; H01M 50/121; H01M 50/129

(52) U.S. Cl. CPC H01M 50/105; H01M 50/119; H01M 50/121; H01M 50/129

(57) ABSTRACT

A secondary battery pouch film according to an exemplary embodiment of the present disclosure is a secondary battery pouch film configured by a laminate in which at least a metal layer and a sealant layer are sequentially laminated. Unevenness is formed on a surface of the sealant layer and a contact angle between the surface of the sealant layer and the electrolyte is 37 degrees to 125 degrees. A secondary battery pouch film according to the present disclosure and a pouch-type secondary battery including the same include unevenness formed on a surface of the sealant layer so that a contact angle with the electrolyte can be adjusted, thereby improving a sealing strength of a sealing portion and being advantageous in terms of lifetime extension.

### CROSS-REFERENCE TO RELATED APPLICATION

This application claims priority to and the benefit of Korean Patent Application No. 10-2024-0191163, filed on Dec. 19, 2024, the disclosure of which is incorporated herein by reference in its entirety.

### BACKGROUND

### Field

The present disclosure relates to a secondary battery pouch film and a pouch-type secondary battery including the same, and more particularly, to a secondary battery pouch film which forms unevenness on a surface of a sealant layer of a secondary battery pouch film and a pouch-type secondary battery including the same.

### National R&D Projects Supporting the Present Invention

[Project ID] 2410004468
[Project No.] 20022450
[Ministry in charge] Ministry of Trade, Industry, and Energy
[Research management (specialist) agency] Korea Planning & Evaluation Institute of Industrial Technology
[Research project name] Development of Technology of Materials and Parts (Outstanding Company)
[Research title] Development of Next-generation Secondary Battery Pouch which is capable of Implementing Twice or higher Adhesive Strength (60)
[Research institution name] Yeul Chon Chemical Co., Ltd.
[Research period] Jan. 1, 2024 to Dec. 31, 2024

### Description of the Related Art

Recently, efforts have been made to reduce the use of fossil fuels due to environmental issues and accordingly, electric vehicles (EV) and energy storage systems (ESS) have been actively developed.

A power source used in the electric vehicles and ESS is a rechargeable secondary battery and a type of an exterior material of the secondary battery may be largely classified into a pouch-type, a cylindrical type, and a prismatic type.

Among these secondary batteries, the pouch-type secondary battery is formed by embedding an electrode assembly in a pouch of a metal laminate sheet so that it has advantages in that a manufacturing cost is lower than the other form factors and specifically, a large capacity battery pack is easily manufactured by connecting a plurality of unit cells in series or in parallel. Therefore, the pouch-type secondary batteries are being actively employed in the markets of the electric vehicles and ESS.

The pouch-type secondary battery is manufactured by accommodating an electrode assembly configured by a positive electrode and a negative electrode and a separator interposed between the positive electrode and the negative electrode in a battery case, injecting an electrolyte, and then sealing. To be more specific, the electrode assembly is accommodated in the battery case and the other sides are sealed except for one side through which the electrolyte is injected. Thereafter, the electrolyte is injected through one side and an activation process is performed, and then the battery case is sealed to manufacture the pouch-type secondary battery. At this time, during the electrolyte injection process, the electrolyte may remain on the sealant layer inside the battery case, which may cause a problem in that a sealing strength of the battery case is degraded due to the remaining electrolyte. Further, there is a problem in that a lifetime characteristic of the pouch-type secondary battery varies depending on the characteristic of the electrolyte that remains on the sealant layer inside the battery case.

### RELATED ART DOCUMENT

### Patent Document

(Patent Document 1) Korean Patent No. 10-2374818 B1

### SUMMARY

The present disclosure has been made to solve the problems as described above and an object thereof is to form an unevenness structure on a sealant layer of a pouch film and allow an appropriate contact angle characteristic with the electrolyte, thereby improving a lifetime characteristic and a sealing characteristic of the pouch-type secondary battery.

According to an exemplary embodiment of the present disclosure, a secondary battery pouch film is a secondary battery pouch film configured by a laminate in which at least a metal layer and a sealant layer are sequentially laminated. Unevenness is formed on a surface of the sealant layer and a contact angle between the surface of the sealant layer and the electrolyte is 37 degrees to 125 degrees.

In the secondary battery pouch film according to an exemplary embodiment of the present disclosure, a contact angle between the unevenness of the surface of the sealant layer and the electrolyte may be 37 degrees to 110 degrees as the Wenzel model.

In the secondary battery pouch film according to an exemplary embodiment of the present disclosure, the contact angle between the unevenness of the surface of the sealant layer and the electrolyte may be 55 degrees to 125 degrees as the Cassie-Baxter model.

In the secondary battery pouch film according to an exemplary embodiment of the present disclosure, in a state in which the secondary battery pouch film is placed upright, a contact angle hysteresis (CAH) angle between the unevenness of the surface of the sealant layer and one electrolyte droplet may be 7 degrees to 12 degrees.

In the secondary battery pouch film according to an exemplary embodiment of the present disclosure, the unevenness may be formed by a process using plasma treatment, corona treatment, or AB agent treatment on the surface of the sealant layer.

The pouch-type secondary battery film according to an exemplary embodiment of the present disclosure includes the secondary battery pouch film.

The pouch-type secondary battery film according to an exemplary embodiment of the present disclosure may further include a sealing surface modified portion in which an unevenness is formed on a surface of a sealant layer of a sealing portion of a battery case.

The pouch-type secondary battery film according to an exemplary embodiment of the present disclosure may further include an inner surface modified portion in which an unevenness is formed on the entire surface of the sealant layer in the battery case.

The pouch-type secondary battery film according to another exemplary embodiment of the present disclosure may further include an inner surface modified portion in which an unevenness is formed on a part of the surface of the sealant layer in the battery case.

In the pouch-type secondary battery film according to another exemplary embodiment of the present disclosure, the inner surface modified portion may be formed to be adjacent to the sealing surface modified portion.

In the pouch-type secondary battery film according to another exemplary embodiment of the present disclosure, an area of the inner surface modified portion may be formed to 5% to 15% of an inner surface area of the battery case.

According to the present disclosure, in a secondary battery pouch film and a pouch-type secondary battery including the same, unevenness is formed on a surface of a sealant layer so that a contact angle with the electrolyte can be adjusted, thereby improving a sealing strength of a sealing portion and being advantageous in terms of lifetime extension.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWING

The above and other aspects, features and other advantages of the present disclosure will be more clearly understood from the following detailed description taken in conjunction with the accompanying drawings, in which:

FIG. 1 is a vertical cross-sectional view of a secondary battery pouch film according to an exemplary embodiment of the present disclosure;

FIGS. 2 to 4 are conceptual views illustrating a contact angle of an electrolyte droplet with respect to a surface of a sealant layer of a secondary battery pouch film according to an exemplary embodiment of the present disclosure;

FIG. 5 is a front view of a pouch-type secondary battery according to an exemplary embodiment of the present disclosure; and

FIG. 6 is an enlarged perspective view of a cut portion of a pouch-type secondary battery according to an exemplary embodiment of the present disclosure.

### DETAILED DESCRIPTION

Hereinafter, various exemplary embodiments of the present disclosure will be described with reference to accompanying drawings. It should be understood that the present disclosure includes various modifications, equivalents, and/or alternatives, without being limited to a specific exemplary embodiment. With regard to the description of drawings, like reference numerals denote like components.

In this specification, the terms “have”, “may have”, “include”, or “may include” represent the presence of the characteristic (for example, a numerical value, a function, an operation, or a component such as a part), but do not exclude the presence of additional characteristics.

In the specification, the terms “A or B”, “at least one of A or/and B”, or “at least one or more of A or/and B” may include all possible combinations of enumerated items. For example, the terms “A or B”, “at least one of A and B”, or “at least one of A or B” may refer to an example which includes (1) at least one A, (2) at least one B, or (3) all at least one A and at least one B.

The expression “configured to (or set to)” may be interchangeably used with “suitable for”, “having the capacity to”, “designed to”, “adapted to”, “made to”, or “capable of” depending on the situation. The terms “configured to (or set)” may not necessarily mean only “specifically designed to”.

The terms used in this specification are merely used to describe a specific embodiment, but do not intend to limit the scope of another embodiment. A singular form may include a plural form if there is no clearly opposite meaning in the context. Terms used herein including technical or scientific terms may have the same meaning as commonly understood by those skilled in the art. Among the terms used in this specification, terms defined in the general dictionary may be interpreted as having the same or similar meaning as the meaning in the context of the related art, but are not ideally or excessively interpreted to have formal meanings unless clearly defined in this specification. In some cases, even though the terms are defined in this specification, the terms are not interpreted to exclude the embodiments of the present specification.

Therefore, configurations of exemplary embodiments described in the present specification are only the most preferred embodiment of the present disclosure and do not represent all of the technical spirit of the present disclosure, and thus it is to be understood that various equivalents and modified examples, which may replace the configurations, are possible when filing the present application.

In the specification, unless explicitly described to the contrary, the word “comprise” and variations such as “comprises” or “comprising”, will be understood to imply the inclusion of stated elements but not the exclusion of any other elements.

Objects, specific advantages, and novel features of the present disclosure explained in the present specification will be more apparent from the following detailed description and exemplary embodiments associated with the accompanying drawings. In the specification, it should be noted that in giving reference numerals to elements of each drawing, like reference numerals refer to like elements even though like elements are shown in different drawings. The terms such as “one surface”, “the other surface”, “first” or “second” may be used to distinguish one constituent element from the other constituent element, but the component is not limited by the above-described terms. Hereinafter, in the description of the present disclosure, detailed descriptions of related known technologies that may unnecessarily obscure the gist of the present disclosure will be omitted

Hereinafter, an exemplary embodiment of the present disclosure will be described in detail with reference to accompanying drawings and the like reference numeral denotes the like component.

A secondary battery pouch film 100 according to an exemplary embodiment of the present disclosure is a secondary battery pouch film 100 configured by a laminate in which at least a metal layer 120 and a sealant layer 130 are sequentially laminated. Unevenness 131 is formed on a surface of the sealant layer 130 and a contact angle between the surface of the sealant layer 130 and an electrolyte is 37 degrees to 125 degrees.

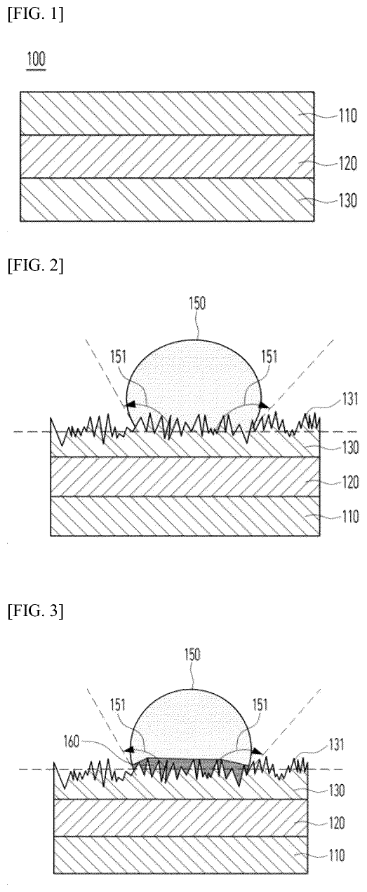

Referring to FIG. 1, the secondary battery pouch film 100 according to an exemplary embodiment of the present disclosure is configured by a laminate including the metal layer 120 and the sealant layer 130. A base layer 110 may be formed on the metal layer 120 to protect the metal layer 120. However, when the metal layer 120 is formed of a material having an excellent corrosion resistance, such as stainless steel, the base layer 110 may not be formed.

The unevenness 131 is formed on the surface of the sealant layer 130. The unevenness 131 of the surface of the sealant layer 130 increases a sealing strength of the sealing portion 220 of the pouch-type secondary battery 200, improves an electrolyte wetting efficiency of an electrode assembly 240, minimizes the loss of the electrolyte, and suppresses the generation of gas to suppress the deterioration, thereby improving the cycle performance.

An interval Rₛₘ of the unevenness 131 may be in the unit of nano meters and a height Rz of the unevenness may be in the unit of micro meters. The unevenness 131 may have a thin and long structure. The interval Rₛₘ of the unevenness 131 refers to an average of the cross-sectional unevenness intervals in a reference length, in a profile obtained by measuring a surface roughness. A height Rz of the unevenness refers to an average length between a highest point and a lowest point, in the profile obtained by measuring a surface roughness.

When the pouch-type secondary battery 200 is manufactured, remaining sealing portions except for one sealing portion are sealed and the electrolyte is injected through the one sealing portion. At this time, the electrolyte remains in the sealant layer 130 on the inner surface of one sealing portion, which may cause degradation of the sealing strength when one sealing portion is thermally fused after injecting the electrolyte. Accordingly, the unevenness 131 is formed on the sealant layer 130 to adjust wettability of the electrolyte to the sealant layer 130.

A surface energy of electrolyte droplets which flow on the sealant layer 130 with the unevenness 131 with the sealant layer 130 is appropriately adjusted so that the electrolyte does not remain on the sealant layer 130 in the form of droplets, while allowing the electrolyte to easily move on the sealant layer 130 in the direction of gravity, thereby reducing residual electrolyte remaining in the sealing portion 220.

A contact angle refers to an angle formed by a liquid surface and a solid wall when liquid is in contact with the solid surface. When the contact angle is larger than 90 degrees, the solid surface is hydrophobic, which results in low wettability of wetting the solid surface with the liquid. When the contact angle is within a range of 0 degrees to 90 degrees, the solid surface is hydrophilic, which results in high wettability of wetting the solid surface with liquid. When the contact angle of the electrolyte on the surface of the sealant layer 130 on which the unevenness 131 is formed is measured, an average height of the surface of the unevenness is calculated to be used as a reference line.

The contact angle between the surface of the sealant layer 130 and the electrolyte is formed at 37 degrees to 125 degrees. When the contact angle is formed to be smaller than 37 degrees, the electrolyte may excessively remain in the unevenness 131, thereby slowing a diffusion rate of the electrolyte inside the pouch-type secondary battery 200 and reducing the wetting efficiency between the electrode assembly 240 and the electrolyte. When the wetting efficiency between the electrode assembly 240 and the electrolyte is reduced, a local electrolyte deficient region may occur, causing side reactions, which results in electrolyte loss and deterioration, thereby adversely affecting the stability and cycle lifetime of the secondary battery. When the contact angle exceeds 120 degrees, the electrolyte is likely to remain on the surface of the sealant layer 130 of the sealing portion 220 in the form of droplets due to the hydrophobicity, which may cause degradation in the sealing strength of the sealing portion 220.

In the secondary battery pouch film 100 according to an exemplary embodiment of the present disclosure, the contact angle between the unevenness 131 on the surface of the sealant layer 130 and the electrolyte may be 37 degrees to 110 degrees as the Wenzel model.

As illustrated in FIG. 2, the Wenzel model explains a situation in which liquid is fully filled in the unevenness of the surface. That is, it refers to a state in which no air pocket is formed between the electrolyte and the unevenness 131. In the case of the pouch-type secondary battery 200, after the process of injecting the electrolyte, the wetting process is performed in a vacuum state so as to allow the electrolyte to sufficiently permeate the electrode and the separator and during this step, air inside the battery is removed to facilitate the penetration of the electrolyte. Accordingly, when the pouch-type secondary battery 200 operates, the Wenzel model situation occurs between the electrolyte and the sealant layer 130 in the battery case 201. When the contact angle exceeds 110 degrees in the Wenzel model situation, the electrolyte is present on the sealant layer 130 in the form of droplets so that a flowability is weakened. Therefore, the electrolyte is not properly delivered to the electrode assembly 240, which weakens the wetting efficiency. Further, in the Wenzel model situation, if the contact angle exceeds 110 degrees, the electrode is likely to flow to be lost without being in contact with the sealant layer 130. In the Wenzel model situation, if the contact angle is smaller than 37 degrees, the electrolyte is more likely to remain adhered to the sealant layer 130, thereby slowing the diffusion rate of the electrolyte and reducing the wetting efficiency. Accordingly, only when the contact angle is formed in an appropriate range, the wetting efficiency between the electrode assembly 240 and the electrolyte is increased, thereby improving the cycle lifetime.

More desirably, the contact angle between the unevenness 131 of the surface of the sealant layer 130 and the electrolyte may be 52 degrees to 84 degrees as the Wenzel model.

In the secondary battery pouch film 100 according to the exemplary embodiment of the present disclosure, the contact angle between the unevenness 131 on the surface of the sealant layer 130 and the electrolyte may be 55 degrees to 125 degrees as the Cassie-Baxter model.

As illustrated in FIG. 3, the Cassie-Baxter model explains a state in which liquid floats on a rough surface and refers to a situation in which air pockets are present between the surface and the liquid. That is, it refers to a state in which an air pocket 160 is formed between the electrolyte and the unevenness 131. When the electrolyte is injected into the pouch-type secondary battery 200, the remaining sealing portions are sealed except for one sealing portion 220 of the pouch, a battery case 201 is placed upright, the electrode assembly is inserted therein, and then the electrolyte is injected to be wetted. Accordingly, the contact angle between the sealant layer 130 of one sealing portion 220 and the electrolyte may be formed by the Cassie-Baxter model. In the Cassie-Baxter model situation, if the contact angle is smaller than 55 degrees, the electrolyte of one sealing portion 220 is more likely to remain adhered to the surface of the sealant layer 130, thereby weakening a sealing strength during the thermal fusion of one sealing portion 220. In the Cassie-Baxter model situation, if the contact angle exceeds 125 degrees, the electrolyte remains on the sealant layer 130 of the sealing portion 220 in the form of droplets, due to hydrophobicity, so that an amount of electrolyte which remains on the sealant layer 130 increases, thereby weakening the sealing strength during the thermal fusion of one sealing portion 220.

More desirably, the contact angle between the unevenness 131 of the surface of the sealant layer 130 and the electrolyte may be 70 degrees to 102 degrees as the Cassie-Baxter model.

In the secondary battery pouch film 100 according to the exemplary embodiment of the present disclosure, in a state in which the secondary battery pouch film 100 is placed upright, a contact angle hysteresis (CAH) angle between the unevenness 131 of the surface of the sealant layer 130 and one electrolyte droplet may be 7 degrees to 12 degrees.

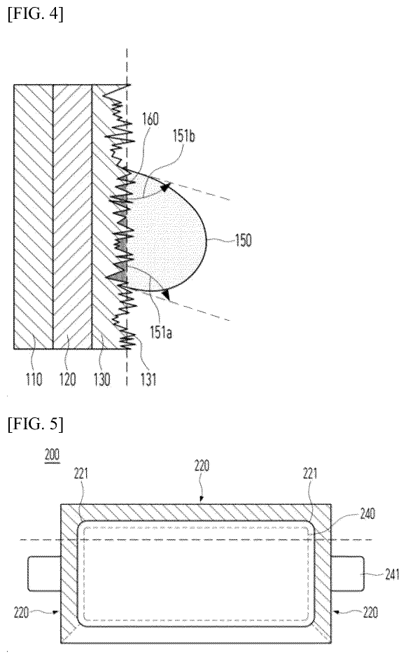

Referring to FIG. 4, the contact angle hysteresis (CAH) refers to a difference in contact angle that appears between an (advancing) process, in which a liquid wets a solid surface, and a (receding) process, in which the liquid withdraws.

The maximum contact angle 151a is an advancing contact angle which is formed when the surface is wetted by the liquid and the minimum contact angle 151b is a receding contact angle which is formed when the liquid withdraws from the surface. The contact angle hysteresis (CAH) angle is defined by a difference between the maximum contact angle 151a and the minimum contact angle 151b.

In a state in which the secondary battery pouch film 100 is placed upright, if the contact angle hysteresis angle exceeds 12 degrees, in one sealing portion 220, the adhesion force between the sealant layer 130 and the electrolyte may become excessively strong, which may deteriorate the sealing strength during thermal fusion of the sealing portion. Further, when the contact angle hysteresis angle exceeds 12 degrees, the surface of the sealant layer 130 is irregular so that the local electrolyte deficient region is highly likely to occur in the pouch-type secondary battery 200, and accordingly, the possibility of gas generation and deterioration due to side reactions is increased.

In the state in which the secondary battery pouch film 100 is placed upright, if the contact angle hysteresis angle is smaller than 7 degrees, the surface of the sealant layer 130 is formed to be superhydrophobic, so that large electrolyte droplets may remain on the sealing portion 220, thereby lowering the sealing strength, and the flowability of the electrolyte along the sealant layer 220 of the inner wall of the cup portion 210 may be lost, resulting in reduced wetting efficiency with the electrode assembly 240.

In the secondary battery pouch film 100 according to the exemplary embodiment of the present disclosure, the unevenness 131 may be formed by performing a plasma treatment, a corona treatment, or an AB agent treatment on the surface of the sealant layer 130.

The plasma treatment on the surface of the sealant layer 130 enables uniform surface treatment, thereby ensuring the uniform wettability between the electrolyte and the electrode assembly 240. According to the corona treatment, the unevenness 131 structure may be formed with a relatively low cost. The AB agent may be used to improve a characteristic of the sealant layer and improve the surface characteristic.

Desirably, the unevenness 131 may be formed by performing the plasma treatment on the surface of the sealant layer 130. When the plasma is injected, the height of the unevenness 131 may be adjusted according to an injected gas ratio and a vacuum degree output. For example, when a ratio of argon gas to oxygen gas of the plasma process gas is set to 8:2, the height of the unevenness may increase, whereas when the ratio of argon gas to oxygen gas is set to 5:5, the height of the unevenness may decrease. Further, when the vacuum degree is formed to 0.52 to 0.8 Torr during the plasma treatment, the height of the unevenness may decrease, whereas when the vacuum degree is formed to 0.1 to 0.3 Torr during the plasma treatment, the height of the unevenness may increase.

The pouch-type secondary battery 200 according to the exemplary embodiment of the present disclosure may include a sealing surface modified portion 221 in which an unevenness 131 is formed on the surface of the sealant layer 130 of the sealing portion 220 of the battery case 201.

Referring to FIG. 4, the sealing surface modified portion 221 may be formed in the sealant layer 130 on which the sealing portion 220 which seals the battery case 201 is formed. The sealing surface modified portion 221 refers that the unevenness 131 is formed on the surface of the sealant layer 130. Accordingly, the sealing strength of the sealing portion 220 may be improved.

The pouch-type secondary battery 200 according to the exemplary embodiment of the present disclosure may include an inner surface modified portion 231 in which an unevenness 131 is formed on the entire surface of the sealant layer 130 in the battery case 201.

The pouch-type secondary battery 200 according to another exemplary embodiment of the present disclosure may include an inner surface modified portion 231 in which an unevenness 131 is formed on a part of the surface of the sealant layer 130 in the battery case 201.

In the pouch-type secondary battery 200 according to another exemplary embodiment of the present disclosure, the inner surface modified portion 231 is formed to be adjacent to the sealing surface modified portion 221.

Referring to FIG. 5, even though the sealant layer 130 is formed on the inner surface of the battery case 201, the modified surface may be formed and is referred to as an inner surface modified portion 231. In the pouch-type secondary battery 200 according to the exemplary embodiment, the inner surface modified portion 231 may be formed in the entire inner surface of the cup portion 210 of the battery case 201.

However, in the pouch-type secondary battery 200 according to another exemplary embodiment of the present disclosure, the inner surface modified portion 231 may be formed to be adjacent to the sealing surface modified portion 221. This is to improve the characteristic of the sealant layer 130 in the vicinity of the sealing portion 220 with respect to the electrolyte, thereby improving the wettability of the electrolyte layer in the vicinity of the sealing portion 220 with respect to the electrode assembly 240.

In the pouch-type secondary battery 200 according to another exemplary embodiment of the present disclosure, an area of the inner surface modified portion 231 may be formed to be 5% to 15% of an inner surface area of the battery case 201.

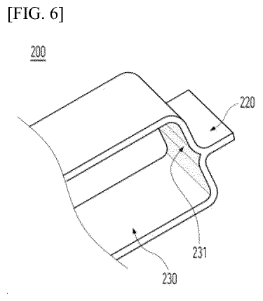

The inner surface modified portion 231 of the pouch-type secondary battery 200 according to another exemplary embodiment of the present disclosure is formed to be adjacent to the sealing surface modified portion 221 and at this time, the inner surface modified portion 231 may be formed on an inner side wall of the battery case 201 as illustrated in FIG. 6. At this time, when the area of the inner surface modified portion 231 is formed to be less than 5% of the inner surface area of the battery case 201, substantially, effects such as electrolyte wetting efficiency, minimization of electrolyte loss, and suppression of gas generation may not be realized inside the battery case 201. Further, when the area of the inner surface modified portion 231 is formed to exceed 15% of the inner surface area of the battery case 201, the inner surface modified portion 231 is also formed on upper and lower walls in the battery case 201. At this time, characteristics of the sealant layer 130 located on the upper and lower walls of the battery case 201 may contribute only minimally to the wettability of the electrolyte and the electrode assembly 240 and may merely lead to increased process costs.

Exemplary implementation examples of the present disclosure will be described in more detail with reference to the following Examples. The Examples disclosed in this specification are provided merely for illustrative purposes, and the Examples of the present disclosure may be implemented in various forms and should not be construed as being limited to the Examples described herein.

### EXAMPLES AND COMPARATIVE EXAMPLES

### Example 1: Manufacture of Secondary Battery Pouch Film

The secondary battery pouch film was designed with an outermost PET layer of 12 μm, a nylon (NY) outer layer of 25 μm, an aluminum (Al) metal layer of 60 μm, and a sealant layer of 80 μm. The plasma treatment was performed on a polypropylene resin surface which was a sealant layer to form the unevenness. At this time, a contact angle of the sealant layer with unevenness and the electrolyte was measured.

### Examples 2 to 16 and Comparative Examples 1 to 16: Manufacture of Secondary Battery Pouch Film

Battery cells of Examples and Comparative Examples were manufactured in the same condition as Example 1 except for the following condition.

TABLE 1

| | [Contact angle] | [Contact angle] |
|---|---|---|
| | Contact angle of | Contact angle of |
| | sealant layer | sealant layer |
| | and electrolyte | and electrolyte |
| Remarks | (Wenzel model) | (Cassie-Baxter model) |
| Example 1 | 37 degrees | 55 degrees |
| Example 2 | 52 degrees | 70 degrees |
| Example 3 | 84 degrees | 102 degrees |
| Example 4 | 117 degrees | 135 degrees |
| Comparative Example 1 | 5 degrees | 23 degrees |
| Comparative Example 2 | 18 degrees | 36 degrees |
| Comparative Example 3 | 27 degrees | 45 degrees |
| Comparative Example 4 | 130 degrees | 148 degrees |

### EXPERIMENTAL EXAMPLE

### Experimental Example 1: Measurement of Sealing Strength

After forming a battery case and accommodating and partially sealing the electrode assembly using the secondary battery pouch film which has been manufactured in Examples 1 to 4 and Comparative Examples 1 to 4, the electrolyte was injected. After injecting the electrolyte, the battery case was completely sealed to measure a sealing strength for the sealing portion in the electrolyte injection direction.

### Experimental Example 2: Measurement of Contact Angle Hysteresis (CAH) Angle

After forming a battery case and accommodating and partially sealing the electrode assembly using the secondary battery pouch film which has been manufactured in Examples 1 to 4 and Comparative Examples 1 to 4, the battery case was placed upright and then the electrolyte was injected. At this time, the contact angle hysteresis (CAH) angle of the electrolyte remaining on the surface of the sealant layer of the sealing portion in the electrolyte injection direction was measured.

The results of Experimental Examples 1 and 2 were represented in the following Table 2.

TABLE 2

| | Sealing | Contact angle |
|---|---|---|
| | strength | hysteresis |
| Remarks | (N/15 mm) | (CAH) angle |
| Example 1 | 197 | 11.7 degrees |
| Example 2 | 188 | 10.3 degrees |
| Example 3 | 187 | 8.9 degrees |
| Example 4 | 186 | 7.3 degrees |
| Comparative Example 1 | 132 | 13 degrees |
| Comparative Example 2 | 123 | 12.4 degrees |
| Comparative Example 3 | 116 | 12.1 degrees |
| Comparative Example 4 | 60 | 5 degrees |

### Experimental Example 3: Lifetime Characteristic

The battery cell was manufactured using the secondary battery pouch film manufactured in Examples 1 to 4 and Comparative Examples 1 to 4. A cup portion was formed in the secondary battery pouch film and then folded to form a battery case, thereafter, the remaining sealing portions, except for one sealing portion, were thermally fused. Thereafter, after placing the battery case upright, the electrolyte was injected through one sealing portion. Thereafter, after performing vacuum wetting and degassing processes, one sealing portion was thermally fused to manufacture the battery cell.

A lifetime characteristic of each case was measured by varying an amount of injected electrolyte. After achieving 500 charging and discharging cycles for each battery cell, the remaining capacity relative to the initial rated capacity was measured and expressed as a percentage.

A result for Experimental Example 3 was represented in Table 3.

TABLE 3

| | Remaining | Remaining | Remaining | Remaining |
|---|---|---|---|---|
| | capacity | capacity | capacity | capacity |
| | (%) when | (%) when | (%) when | (%) when |
| | injecting | injecting | injecting | injecting |
| | 2.7 g of | 3 g of | 3.3 g of | 3.6 g of |
| Remarks | electrolyte | electrolyte | electrolyte | electrolyte |
| Ex. 1 | 75 | 79 | 83 | 87 |
| Ex. 2 | 79 | 83 | 87 | 91 |
| Ex. 3 | 80 | 84 | 88 | 92 |
| Ex. 4 | 75 | 79 | 83 | 87 |
| Com. Ex. 1 | 33 | 37 | 41 | 45 |
| Com. Ex. 2 | 42 | 46 | 50 | 54 |
| Com. Ex. 3 | 48 | 52 | 56 | 60 |
| Com. Ex. 4 | 73 | 77 | 81 | 85 |

Hereinabove, although the present disclosure has been described in detail through specific examples, this is intended to specifically explain the present disclosure and the present disclosure is not limited thereto, and it will be apparent that modifications or improvements can be made by those skilled in the art within the technical spirit of the present disclosure.

All simple modifications or changes of the present disclosure fall within the scope of the present disclosure and the specific protection scope of the present disclosure will be made clear by the appended claims.

What is claimed is:

1. A secondary battery pouch film configured by a laminate in which at least a metal layer and a sealant layer are sequentially laminated, wherein unevenness is formed on a surface of the sealant layer and a contact angle between the surface of the sealant layer and an electrolyte is 37 degrees to 125 degrees.

2. The secondary battery pouch film according to claim 1, wherein a contact angle between the unevenness of the surface of the sealant layer and the electrolyte is 37 degrees to 110 degrees as Wenzel model.

3. The secondary battery pouch film according to claim 2, wherein the contact angle between the unevenness of the surface of the sealant layer and the electrolyte is 55 degrees to 125 degrees as Cassie-Baxter model.

4. The secondary battery pouch film according to claim 3, wherein in a state in which the secondary battery pouch film is placed upright, a contact angle hysteresis (CAH) angle between the unevenness of the surface of the sealant layer and one electrolyte droplet is 7 degrees to 12 degrees.

5. The secondary battery pouch film according to claim 1, wherein the unevenness is formed by a process using plasma treatment, corona treatment, or AB agent treatment on the surface of the sealant layer.

6. A pouch-type secondary battery, comprising the secondary battery pouch film according to claim 1.

7. The pouch-type secondary battery according to claim 6, further comprising:
a sealing surface modified portion in which an unevenness is formed on the surface of the sealant layer of a sealing portion of a battery case.

8. The pouch-type secondary battery according to claim 6, further comprising:
an inner surface modified portion in which an unevenness is formed on the entire surface of the sealant layer in a battery case.

9. The pouch-type secondary battery according to claim 6, further comprising:
an inner surface modified portion in which an unevenness is formed on a part of the surface of the sealant layer in a battery case.

10. The pouch-type secondary battery according to claim 9, wherein the inner surface modified portion is formed to be adjacent to the sealing surface modified portion.

11. The pouch-type secondary battery according to claim 10, wherein an area of the inner surface modified portion is formed to 5% to 15% of an inner surface area of the battery case.
